(19) United States
(12) Patent Application Publication
(10) Pub. No.: US 2006/0154050 A1
(43) Pub. Date: Jul. 13, 2006

(54) Holographic transfer thermoplastic sheet

(75) Inventors: John Fitch, Middletown, RI (US); Steven J. Sargeant, Kingston, RI (US); Eric Bartholomay, Coventry, RI (US)

Correspondence Address: Barry E. Bretschneider;Morrison & Foerster LLP, Suite 300, 1650 Tysons Boulevard, McLean, VA, 22102, US

(73) Assignee: Toray Plastics (America), Inc., a corporation of Rhode Island, North Kingstown, RI (US)

(21) Appl. No.: 10/848,439

(22) Filed: May 18, 2004

(51) Int. Cl. B32B 27/38; B32B 27/40; B32B 27/36; B32B 27/30; B32B 27/00

(52) U.S. Cl. 428/336; 428/343; 428/480; 428/339; 428/910; 428/522; 428/413; 428/423.1; 427/402; 427/171; 156/209

(57) ABSTRACT

A directly embossable, coated polyethyleneterephthalate film including a dry, uniaxially oriented PET film, and a coating applied to the PET film, wherein the coating and the PET film have as a composite been transversely stretched, the coating resin being capable of impregnating the PET surface on drawing, rendering the film surface susceptible to embossing under pressure and the coating having low heat sealability and a method of producing a coated, directly embossable polyethyleneterephthalate film.

### TECHNICAL FIELD

This invention relates to a holographically embossable sheet. This invention further relates to a coated film with exceptional embossing characteristics and a method of transferring a hologram to other surfaces. This invention also relates to a method of making the coated film.

### BACKGROUND

Holograms and diffraction gratings are images that diffract light created by the texturizing of a substrate under heat and pressure. Such images are used to create decorative packaging, security products and a host of other uses. The embossed substrates are often metallized to create high contrast. Such metallized substrates are found on credit cards, membership materials, board laminates, labels, toys, packaging materials and many commodity products.

Currently, it is known in the art to produce holograms by embossing polyvinyl chloride (PVC), polyethyleneterephthalate (PET), biaxially oriented polypropylene (BOPP), polystyrene (PS), polyamides (PA) such as Nylon® or other plastic materials. It is also known in the art to produce holographic substrates by coating a relatively thick acrylic layer on the substrate by a coating process when the substrates are BOPP or PET. Coating is done in an off-line process by hologram manufacturers at the point of use of the web substrate in the case of PET substrates. However, it is desirable to obtain a pre-coated and embossable PET film from a substrate manufacturer that can directly accept the holographic texture. Such a material would obviate the need for hologram manufacturers to coat the base materials and reduce overall costs of manufacturing. Furthermore, it is often desirable to transfer the holographic image to another surface such as paper board stock. The underlying substrate is then peeled away when transferring the holographic image to yield the hologram deposited on the substrate. It is virtually impossible to remove the holographic texture from the substrate due to the integration of the holographic texture with the plastic film itself in the case of directly embossed PVC or BOPP.

It is deemed necessary to provide a thick, embossable surface on the PET film to produce a directly embossed film at the point of film manufacture. Such a surface can be provided either through a co-extrusion process or, for example, through an inline coating process. It is necessary to produce a surface layer with many of the same characteristics of PET in the case of co-extrusion. Therefore, IV, melt strength, melt viscosity and the like are important parameters for the co-extruded layer in the PET film making process. Typical materials that can survive this process are often analogs of PET itself. These materials suffer the problem of having low crystallinity and are, therefore, heat-sealable. A heat-sealable material often sticks to the embossing shim rendering the embossed texture of little commercial quality.

U.S. Pat. No. 4,913,858 describes offline coating for holographic embossing use.

U.S. Pat. No. 3,758,649 describes embossing directly into a thermoplastic sheet.

Commonly assigned, co-pending Published U.S. Patent Application Document Number 2003 0108756 describes a directly embossable, coated polyethyleneterephthalate film including a dry, uniaxially oriented PET film, and a coating applied to the PET film, wherein the coating and the PET film have as a composite been transversely stretched, the coating resin being capable of impregnating the PET surface on drawing, rendering the film surface susceptible to embossing under pressure and the coating having low heat sealability and a method of producing a coated, directly embossable polyethyleneterephthalate film.

Commonly assigned, co-pending Published U.S. Patent Application Document Number 2003 0077467 describes a directly embossable, coated polyethyleneterephthalate film including a dry, uniaxially oriented PET film, and a coating applied to the PET film, wherein the coating and the PET film have, as a composite, been transversely stretched, the film being coated with an aqueous solution at a thickness of about 0.1 μm to about 0.4 μm with a non-cross-linked polystyrene-acrylic emulsion and non-cross-linked polyester dispersion, the T_{g} of the coating resin being greater than about 20° C. and less than about 70° C., the coating resin being capable of impregnating the PET surface on drawing, rendering the film surface susceptible to embossing under pressure and the coating having low heat sealability. It also describes a method of producing a coated, directly embossable polyethyleneterephthalate film including uniaxially stretching a polyethyleneterephthalate film to form a uniaxially oriented polyethylene-terephthalate film, drying the uniaxially oriented polyethyleneterephthalate film, coating at least one surface of the uniaxially oriented polyethyleneterephthalate film with an aqueous solution of an organic material, drying the coating to form a coated uniaxially oriented polyethylene-terephthalate film, rendering at least one surface of the coated uniaxially oriented polyethylene-terephthalate film susceptible to direct embossing by impregnation of the surface of the uniaxially oriented polyethyleneterephthalate film with at least a portion of the coating by transverse stretching the coated, uniaxially oriented polyethyleneterephthalate film.

Other known publications include:

Creating Interference Colors on Thermoplastic Films Without Colorants, Trudy Bryson, Coburn Corporation, 1982;

Dimension, design and printability, James Coburn;

Holographic Advances Open New Dimensions For Converters, S. F. Mann, Dennison Mfg. Co. 1986; and

Optical Embossing, James River Products.

The disclosures of the foregoing are incorporated herein by reference in their entireties.

### SUMMARY OF THE INVENTION

This invention relates in one aspect to a transferable, embossable, coated polyethyleneterephthalate (PET) film including a uniaxially oriented PET base film, and a coating applied to the PET base film, wherein the coating and the PET base film have as a composite been transversely stretched, the coating resin impregnating a surface portion of the PET base film upon the transverse stretching, thereby rendering the surface portion of the film susceptible to embossing.

This invention also relates to an embossable and transferable, coated polyethyleneterephthalate film including a uniaxially oriented PET base film, a coating applied to the PET base film, wherein the coating and the PET base film have as a composite been transversely stretched, the coating resin impregnating a surface portion of the PET base film upon transverse stretching and rendering the surface portion of the base film susceptible to embossing and a low T_{g} laminating adhesive layer that enables the coating to transfer to a secondary substrate via the low T_{g} laminating adhesive layer.

This invention further relates to a method of producing a coated, directly embossable polyethyleneterephthalate (PET) film including stretching a PET film to form a uniaxially oriented PET film, drying the uniaxially oriented PET film, coating at least one surface of the uniaxially oriented PET film with an aqueous solution of an organic material, rendering at least one surface of a resulting coated uniaxially oriented PET film susceptible to direct embossing by impregnating the surface of the uniaxially oriented PET film with at least a portion of the coating by transverse stretching the coated uniaxially oriented PET film, and applying a low T_{g} laminating adhesive layer to the coating.

This invention still further relates to making a laminate structure containing a holographic image including stretching a PET film to form a uniaxially oriented PET film, drying the uniaxially oriented PET film, coating at least one surface of the uniaxially oriented PET film with an aqueous solution of an organic material, rendering at least one surface of a resulting coated uniaxially oriented PET film susceptible to direct embossing by impregnating the surface of the uniaxially oriented PET film with at least a portion of the coating by transverse stretching the coated uniaxially oriented PET film, applying a metal layer on the coating, applying a low T_{g} laminating adhesive film to the metal layer, and laminating a transfer substrate to the adhesive layer.

This invention still yet further relates to a method of making a holographic image on a substrate including stretching a PET film to form a uniaxially oriented PET film, drying the uniaxially oriented PET film, coating at least one surface of the uniaxially oriented PET film with an aqueous solution of an organic material, rendering at least one surface of a resulting coated uniaxially oriented PET film susceptible to direct embossing by impregnating the surface of the uniaxially oriented PET film with at least a portion of the coating by transverse stretching the coated uniaxially oriented PET film, applying a metal layer on the coating, applying a low T_{g} laminating adhesive film to the metal layer, laminating a transfer substrate to the adhesive layer, and removing the PET base film.

These and other features and advantages of the invention will be more fully understood from the following description of certain specific embodiments of the invention.

### DETAILED DESCRIPTION

We discovered a method to render PET embossable via incorporation of a unique surface coating. The coating can be applied to PET film during the film making process to render the PET film itself embossable by impregnating the PET and softening the upper layer of the film structure. The composite structure is then embossable without the need for a secondary coating step. Furthermore, this material maintains its embossability without acting as an easily heat-sealable material. Such properties are advantageous for low cost production of holographic images.

We further discovered that embossability of an inline coated polyester film is enhanced by utilizing a smooth surface material and, optionally, a co-extruded co-polyester surface layer as the coating surface. Such a base sheet polyester can be prepared with equipment and materials known in the art. An embossable thermoplastic sheet has been discovered having enhanced image properties, namely reduced granularity or graininess of the embossed image by combining a co-extruded film structure and an inline embossable film coating process.

As set forth above, a uniaxially oriented PET film can be coated during the film-making process. This coating is then dried and stretched in the transverse direction. We determined that certain coatings impregnate the upper surface of the polyester film during the transverse stretching operation. This renders the upper polyester surface modified. We further discovered certain coatings that render the upper surface of the polyester film pliable, but not heat sealable, such that this modification to the polyester film renders the composite film structure capable of being embossed under heat and pressure. This makes the composite PET film processable for holographic film use without the need for a secondary coating step.

We also discovered that the pliability of the upper surface of the PET film can be modified to further increase the image appearance of a hologram. Co-extrusion of a co-polyester or smooth surface material results in an increase to the overall quality of the hologram. Accordingly, it is preferable to use a PET base film that is co-extruded and forms at least two layers. Also, the PET base film preferably contains particles such as, but not limited to, silica, alumina, calcium carbonate and mixtures thereof, as well as others. Such particles are preferably present in an amount of from about 0.005 weight percent (wt %) to about 0.6 wt %, based on the weight of the PET film.

The PET film preferably has a thickness of about 4.5 μm to about 60 μm. The PET base film is preferably stretched in an amount of about 3.4 to about 5.4 times and the coated PET film, as a composite, is preferably stretched in an amount of about of 3.3 to about 4.6 times in the transverse direction.

As noted above, the coating material is most preferably selected from non-cross-linked polystyrene-acrylic emulsions and a non-cross-linked polyester dispersion, although other coatings may be used. The coating most preferably has a thickness of from about 0.1 μm to about 0.4 μm.

The co-extruded layers preferably comprise a polyester layer and a co-polyester layer. The co-polyester layer may be formed from isophthalic acid or a derivative of cyclohexane dimethanol, as well as other components. The co-polyester layer preferably has a thickness between from about 0.1 μm to about 3.0 μm. In addition, the co-polyester layer preferably has a surface which contacts the coating and has a roughness Ra of less than about 40 nm.

The laminating substrate in accordance with aspects of the invention preferably comprises a material including, but not limited to, the following:

Cloth,

Paper board,

Filmic substrates including, but not limited to, PVC (polyvinylchloride), BOPP (biaxially oriented polypropylene), BOPET (biaxially oriented polyethyleneterephthalate),

and the like.

The low T_{g} laminating adhesive layer preferably comprises, but is not limited to, the following:

Internally or externally plasticized copolyesters,

Internally or externally plasticized acrylics,

Epoxy based resins,

PVA (polyvinylacetate) based resins,

Polyurethane based laminating adhesive and the like.

The T_{g} range is roughly about −40C to about 20C.

The invention will be further described hereinafter with reference to examples which are intended as being illustrative of the invention and in no way are to be construed as limiting thereof.

Embossing evaluation of the coated films was performed as set forth below.

A 12 ton Carver hydraulic hot press Model # 3912 with 6×6 inch heated platens was used to evaluate the embossing capabilities of the coated film material. A 4×4 inch nickel embossing shim was placed on top of a 4×4 inch sample. Both platens were heated to 220° F. The film sample and shim were pressed together for 10 seconds at 400 psi. The sample was removed and placed on a bench top to cool. The film was then slowly peeled off the shim at a 45 degree angle.

The sample was then placed on a black background to enhance the visibility of the embossed image and rated visually as follows:

Excellent=Bright colors aviewed from many angles with no unembossed areas.

Good=Colors not as robust from different angles.

Fair=Colors not as bright.

Poor=Colors dull with unembossed areas.

The following evaluations were performed to evaluate transfer properties of the subsequent holograms.

Holographically embossed films as described above were coated with an adhesive system. This was accomplished with a wire wound (Myer) bar. The adhesively coated films were then hot roll laminated to a transfer substrate utilizing a heat roll laminator. Lamination nip pressure was approximately 80 psi and the materials were processed at about 0.5 feet/second. The laminated structures were peeled apart after a brief cool down period. The amount of transfer was quantified.

Examples

Smooth Base Film Preparation For Examples 1-3

A polyester base film was prepared as follows:

Polyethylene terephthalate was polymerized by a known method: A melt slurry of ethylene glycol and purified terephthalic acid was heated in the presence of an esterification catalyst. Water and excess ethylene glycol were removed under vacuum leaving a residual melt of polyester. This melt was discharged via strand die into a cooling trough, pelletized, and then further dried to remove residual moisture to less than 50 ppm. Trimethylphosphate of 0.032 wt %, magnesium acetate of 0.060 wt %, antimony trioxide of 0.026 wt %, and tetraethyl ammonium hydroxide of 0.252 wt %, were also used to prepare polyester A. External particles were not added to polyester A.

Polyethylene terephthalate was polymerized by a known method: A melt slurry of ethylene gylcol and purified terephthalic acid was heated, in the presence of an esterification catalyst. Water and excess ethylene glycol were removed under vacuum leaving a residual melt of polyester. This melt was discharged via strand die into a cooling trough, pelletized, and then further dried to remove residual moisture to less than 50 ppm. Lithium acetate dihydrate of 0.226%, trimethylphosphate of 0.181 wt %, phosphorous acid of 0.020 wt %, antimony trioxide of 0.04 wt %, and calcium acetate of 0.119 wt %, were used to prepare polyester B.

SiO₂ particles (Particles (A)) having an average particle size of about 2.6 μm were admixed into polyethylene terephthalate polymerized by a known method: A melt slurry of ethylene glycol and purified terephthalic acid was heated in the presence of an esterification catalyst. Water and excess ethylene glycol were removed under vacuum leaving a residual melt of polyester. This melt was discharged via strand die into a cooling trough, pelletized, and then further dried to remove residual moisture to less than 50 ppm. Tetraethyl ammonium hydroxide of 0.049 wt %, lithium acetate dihydrate of 0.882 wt %, antimony trioxide of 0.039 wt %, and calcium acetate of 0.090 wt %, and trimethylphosphate of 0.042 wt % were also used to prepare polyester C. The content of particles (A) in pellets formed from polyester (C) was 2.0%.

Next, 48.5 parts by weight of pellets formed from polyester (A), 48.5 parts by weight of pellets formed from polyester (B), and 3.0 parts by weight of pellets (C), were mixed. The mixed pellets were extruded using a vent type two-screw extruder to produce melt stream (I). Next, 48.5 parts by weight of pellets (A), 48.5 parts by weight of pellets (B), and 3.0 parts by weight of pellets (C), were mixed. Up to 55% recycle consisting of finished film can replace equal parts of polymer A and polymer B. The mixed pellets were dried under vacuum at 150° C. for 3 hours and extruded to produce melt stream (II). Melt stream (I) was fed through a rectangular joining zone where it was laminated to a melt stream of polyester (II). The laminate produced a three layer co-extruded I/II/I structure where polymer (I) and polymer (II) were substantially the same. The extruded polymer was delivered through a die in the form of a molten curtain. The resulting melt curtain was quenched on a casting drum, and then biaxially oriented via subsequent stretching steps on a roller train and chain driven transverse stretcher as is known in the art. The total thickness of the film is not particularly important. Typical end use conditions range from about 4.5 μm to about 60 μm.

The uniaxially oriented co-extruded PET film can be coated during the film-making process. This coating is then dried and stretched in the transverse direction. Such a process is known in the art. We discovered the advantageous use of a smooth and/or amorphous base film coupled with an embossable surface coating to render a brightly embossed PET film material.

Description of Graininess

Judging the quality of embossing is subjective, depending on the visual acuity of the observer and the observation angle, as well as the mood of the observer. A method was devised that can be used to judge the quality of embossing by the gloss level to better quantify graininess and, hence, the embossing quality.

Equipment:

BYK Chemie glossmeter

Film holder

Procedure:

1. A rainbow shim pattern (a standard well-known embossing pattern in the industry) was used to emboss an image into a sample.

2. The sample was aluminum metallized in a bell jar metallizer, or if the sample was made at wide web, in a roll to roll metallizer.

3. The embossed and metallized sample was pulled taut in a film holder.

4. An 85° angle of illumination was used.

5. 3 readings were taken in the films transverse direction and averaged.

The gloss readings were then compared with a subjective visual rating of the embossing.

### EXAMPLES

### Example 1

Coating solution #1

| | |
|---|---|
| Styrene acrylic emulsion (1) | 49.0 Parts |
| Acetylenic Surfactant (2) | 0.01 Parts |
| Propylene glycol phenyl ether (3) | 1.2 Parts |
| Deionized Water | 49.0 Parts |

(1) Setalux 37-3372 sold by Akzo Nobel
(2) Surfynol 440 sold by Air Products
(3) Dowanol PPH, Dow Chemical Inc.

Coating solution #1 was coated onto uniaxially oriented PET utilizing a #4 wire wound bar. This coating was dried and then the PET film drawn in the transverse direction to a stretching ratio of about 3.8 to produce a composite PET film with a surface coating thickness of about 0.4 μm. Very good embossing was received under the test conditions. These films were then metallized to increase the contrast of the hologram to further facilitate evaluation of the transfer properties.

The following procedure was then performed to determine holographic transfer:

1. Holographically embossed and metallized sheets were coated with an adhesive.

2. The adhesive coated sheets were dried in an oven to remove the carrier solvent or aqueous vehicle.

3. The adhesive coated hologram was brought into surface contact with a transfer substrate utilizing light hand pressure.

4. The lightly laminated structure was put into a hot roll laminator and, under heat and pressure, completely laminated to form a sandwich structure.

5. The sandwich structure was separated and the amount of holographic transfer and the visually properties of the hologram were determined.

### Example 1a

A styrene acrylic heat seal adhesive, commercially available from Johnson Polymers as “Joncryl 750” was coated on the metallized and embossed hologram. The materials were laminated into a sandwich structure under heat and pressure. After laminating, the PET layer was peeled away and the degree and amount of holographic transfer was determined to be excellent.

### Example 1b

An aqueous (ethylene vinyl chloride) based laminating adhesive, commercially available from AirProducts as “Airflex 4514” was coated onto the embossed and metallized hologram using a #30 mayer rod. The materials were laminated into a sandwich structure under heat and pressure. The layers were separated after the lamination step. Approximately 90% of the embossed and metallized holographic coating transferred.

### Example 1c

An aqueous (ethylene vinyl chloride) based laminating adhesive, commercially available from AirProducts as “Airflex 4514” was coated onto the embossed and metallized hologram using a #10 mayer rod. The materials were laminated into a sandwich structure under heat and pressure. The layers were separated after the lamination step. Approximately 60% of the embossed and metallized holographic coating transferred. This is deemed the minimum for acceptable commercial transfer.

### Example 1d

An aqueous (ethylene vinyl chloride) latex, commercially available from AirProducts as “Airflex 420” was coated onto the embossed and metallized hologram. The materials were laminated into a sandwich structure under heat and pressure. The layers were separated after the lamination step. Approximately 90% of the embossed and metallized holographic coating transferred.

### Comparative Example 1

A solvent based, acrylic, laminating adhesive, commercially available from National Starch as 38-8569 was coated onto the embossed and metallized hologram. The materials were laminated into a sandwich structure under heat and pressure. The materials were separated after the lamination step. No holographic transfer was noted.

### Comparative Example 2

The base PET film as described above was coated with the following surface layer between the first and second stretching operations:

Coating solution #2

| | |
|---|---|
| Sulphopolyester dispersion (4) | 20 Parts |
| Sulphopolyester dispersion (5) | 40 Parts |
| Acetylenic surfactant (2) | 0.01 Parts |
| Deionized Water | 40 Parts |

(4) Eastek 1200-10 sold by Lawter International
(5) Eastek 1000 sold by Lawter International

Coating solution #2 was coated onto uniaxially oriented PET utilizing a #4 wire wound bar. This coating was dried and then the PET film drawn in the transverse direction to produce a composite PET film with a surface coating thickness of about 0.4 μm. This coated PET film was then drawn in the transverse direction. Very good embossing was received under the test conditions.

The procedure described above was then performed to determine holographic transfer.

This film was then adhesively coated as follows:

A styrene acrylic heat seal adhesive, commercially available from Johnson Polymers as “Joncryl 750” was coated on the metallized and embossed hologram using a #30 mayer rod. The materials were laminated into a sandwich structure under heat and pressure. After laminating the PET layer was peeled away and the degree and amount of holographic transfer was determined to be poor.

Co-extruded Co-polyester Base Layer For Examples 2-3:

An amorphous co-extruded surface layer for the polyester thermoplastic film was prepared as follows:

An isophthalic acid co-terephthalic acid random co-polyester co-polymer with an IV of about 0.65 and a mol ratio of about 18% isophthalic acid to 82% terephthalic acid, commercially available from Dupont as Selar 8306, was co-extruded on a base sheet of polyethylene-terephthalate. The base sheet of polyethyleneterephthalate can be prepared as described above for the core layer. Alternatively, a co-polyester consisting of a random co-polymer of cyclo-hexane dimethanol residues, commercially available from Eastman Chemical, with an IV of about 0.70 can be utilized as the amorphous layer. The thickness of the amorphous layer was varied.

The amorphous co-polyester surface was coated as described below after the forward draw of the A/B co-extruded film. The coated film was then dried and transversely stretched to produce the final film structure.

### Example 2

Coating solution #1

| | |
|---|---|
| Styrene acrylic emulsion (1) | 49.0 Parts |
| Acetylenic Surfactant (2) | 0.01 Parts |
| Propylene glycol phenyl ether (3) | 1.2 Parts |
| Deionized Water | 49.0 Parts |

Coating solution #1 was coated onto uniaxially oriented co-polyester PET utilizing a #4 wire wound bar. The surface layer of I-PET was approximately 0.6 μm. This coating was dried and then the PET film drawn in the transverse direction to a stretching ratio of about 3.8 to produce a composite PET film with a surface coating thickness of about 0.4 μm. Excellent embossing was received under the test conditions.

### Example 3

The base layer as shown in Example 2 was coated with the following surface layer:

Coating solution #2

| | |
|---|---|
| Sulphopolyester dispersion (3) | 20 Parts |
| Sulphopolyester dispersion (4) | 40 Parts |
| Acetylenic surfactant (2) | 0.01 Parts |
| Deionized Water | 40 Parts |

Coating solution #2 was coated onto uniaxially oriented PET utilizing a #4 wire wound bar. This coating was dried and then the PET film drawn in the transverse direction to produce a composite PET film with a surface coating thickness of about 0.4 μm. This coated PET film was then drawn in the transverse direction. Excellent embossing was received under the test conditions.

### Reference Comparative Example 1

A commercially available sample of AET's A-Boss embossable polypropylene was embossed under the test conditions. The sample showed good embossing characteristics with low graininess.

A styrene acrylic heat seal adhesive, commercially available from Johnson Polymers as “Joncryl 750” was coated on the metallized and embossed hologram. The materials were laminated into a sandwich structure under heat and pressure. The polypropylene layer was peeled away after laminating and the degree and amount of holographic transfer was determined to be 0% transfer. This product/process is not suitable for use in transfer embossing.

### Comparative Example 3

The co-extruded co-polyester base layer as described in Examples 2 and 3 was prepared without a surface coating. The film was embossed under typical embossing conditions illustrative for the other examples. The sample showed marginal embossing characteristics. These films were not further evaluated for transfer characteristics.

### Comparative Example 4

A commercially available packaging grade of PET film was acquired from Toray Plastics Europe known as 10.41. This film is manufactured with an acrylic coating on one side with a reverse face of co-extruded CHDM copolyester. The copolyester surface was embossed under the conditions described herein for the other examples. The sample had marginal embossing characteristics. These films were not evaluated further for transfer characteristics.

While the invention has been described by reference to certain embodiments, it should be understood that numerous changes could be made within the spirit and scope of the inventive concepts described. Accordingly, it is intended that the invention not be limited to the disclosed embodiments, but that it have the full scope permitted by the language of the following claims.

1. An embossable and transferable, coated polyethyleneterephthalate film comprising:
a uniaxially oriented PET base film;
a coating applied to the PET base film;
wherein the coating and the PET base film have as a composite been transversely stretched, the coating resin impregnating a surface portion of the PET base film upon the transverse stretching and rendering the surface portion of the base film susceptible to embossing; and
a low T_{g} laminating adhesive layer that enables transfer of the coating, subsequent to embossing, to a secondary substrate.

2. The film of claim 1, wherein the PET base film is co-extruded to comprise at least two layers.

3. The film of claim 1, wherein the PET film has a thickness of about 4.5 μm to about 60 μm.

4. The film of claim 1, wherein the PET base film contains particles.

5. The film of claim 4, wherein the particles are selected from the group consisting of silica, alumina, calcium carbonate and mixtures thereof.

6. The film of claim 4, wherein particles are present in an amount of about 0.005 wt % to about 0.6 wt %, based on the weight of the PET film.

7. The film of claim 1, wherein the adhesive layer comprises an acrylic, a urethane or a polyester solvent based adhesive.

8. The film of claim 1, wherein the PET base film is stretched in an amount of about 3.4 to about 5.4 times.

9. The film of claim 1, wherein the coated PET film, as a composite, is stretched in an amount of about 3.3 to about 4.6 times in the transverse direction.

10. The film of claim 1, wherein the coating is formed from a material selected from the group consisting of a non-cross-linked polystyrene-acrylic emulsion and non-cross-linked polyester dispersion.

11. The film of claim 1, wherein the coating has a thickness of about 0.1 μm to about 0.4 μm.

12. The film of claim 2, wherein the co-extruded layers comprise a polyester layer and a co-polyester layer.

13. The film of claim 12, wherein the co-polyester layer is formed from isophthalic acid or a derivative of cyclohexane dimethanol.

14. The film of claim 1, wherein the co-polyester layer has a thickness of from about 0.1 μm to about 3.0 μm.

15. The film of claim 1, wherein the co-polyester layer has an upper surface contacting the coating and has a roughness Ra of about 40 nm.

16. The film of claim 1, further comprising a metal layer located between the coating and the adhesive.

17. The film of claim 16, wherein the surface of the base film and the metal layer are embossed.

18. The film of claim 1, wherein the surface of the base film is embossed.

19. The film of claim 1, wherein the low T_{g} laminating adhesive layer is selected from the group consisting of internally or externally plasticized copolyester, internally or externally plasticized acrylics, epoxy-based resins, PVA (polyvinylacetate) based resins and polyurethane-based laminating adhesive.

20. A holographic laminate structure comprising:
a uniaxially oriented PET base film;
a coating applied to the PET base film;
wherein the coating of a PET base film have as a composite been transversely stretch, the coating resin impregnating a surface portion of the PET base film upon transverse stretching and rendering the surface portion of the base film susceptible to embossing;
a metal layer applied to the coating, wherein the surface of the base film and the metal layer are embossed;
a low T_{g} laminating adhesive layer applied to the metal layer; and
a transfer substrate laminated to the adhesive layer.

21. A method of producing a coated, directly embossable polyethyleneterephthalate (PET) film comprising:
stretching a PET film to form a uniaxially oriented PET film;
drying the uniaxially oriented PET film;
coating at least one surface of the uniaxially oriented PET film with an aqueous solution of an organic material;
rendering at least one surface of a resulting coated uniaxially oriented PET film susceptible to direct embossing by impregnating the surface of the uniaxially oriented PET film with at least a portion of the coating by transverse stretching the coated uniaxially oriented PET film; and
applying a low T_{g} laminating adhesive layer to the coating.

22. The method of claim 21, wherein the PET base film is co-extruded and forms at least two layers.

23. The method of claim 21, wherein the PET film has a thickness of about 4.5 μm to about 60 μm.

24. The method of claim 21, wherein the PET film contains particles.

25. The method of claim 21, wherein the PET film contains particles selected from the group consisting of silica, alumina, calcium carbonate and mixtures thereof.

26. The method of claim 21, wherein the PET film contains particles and which particles are present in the amount of about 0.005 wt % to about 0.6 wt %, based on the weight of the PET film.

27. The method of claim 21, wherein the PET film is stretched in an amount of about 3.4 to about 5.4 times.

28. The method of claim 21, wherein the coated PET film is stretched in an amount of about 3.3 to about 4.6 times in the transverse direction.

29. The method of claim 21, wherein the coating is formed from a material selected from the group consisting of a non-cross-linked polystyrene-acrylic emulsion and non-cross-linked polyester dispersion.

30. The method of claim 21, wherein the coating has a thickness of about 0.1 μm to about 0.4 μm.

31. The method of claim 21, wherein the co-extruded layers comprise a polyester layer and a co-polyester layer.

32. The method of claim 21, wherein the co-polyester layer is formed from isophthalic acid or a derivative of cyclohexane dimethanol.

33. The method of claim 21, further comprising embossing selected surface portions of the PET film under pressure.

34. The method of claim 21, wherein the co-polyester layer has a thickness between about 0.1 μm and 3.0 μm.

35. The method of claim 34, wherein the co-polyester layer has an upper surface contacting the coating and has a roughness Ra of about 40 nm.

36. The method of claim 21, further comprising:
applying a metal layer on the coating.

37. A method of making a laminate structure containing a holographic image comprising:
stretching a PET film to form a uniaxially oriented PET film;
drying the uniaxially oriented PET film;
coating at least one surface of the uniaxially oriented PET film with an aqueous solution of an organic material;
rendering at least one surface of a resulting coated uniaxially oriented PET film susceptible to direct embossing by impregnating the surface of the uniaxially oriented PET film with at least a portion of the coating by transverse stretching the coated uniaxially oriented PET film;
applying a metal layer on the coating;
embossing the coating and the metal layer;
applying a low T_{g} laminating adhesive film to the metal layer; and
laminating a transfer substrate to the adhesive layer.

38. The method of claim 37, wherein the transfer substrate is made from a material selected from the group consisting of cloth, paper board and filmic substrates selected from the group consisting of PVC (polyvinylchloride), BOPP (biaxially oriented polypropylene) and BOPET (biaxially oriented polyethyleneterephthalate.

39. The method of claim 37, wherein the metal layer is applied by vacuum pressure.

40. A method of making a holographic image on a substrate comprising:
stretching a PET film to form a uniaxially oriented PET film;
drying the uniaxially oriented PET film;
coating at least one surface of the uniaxially oriented PET film with an aqueous solution of an organic material;
rendering at least one surface of a resulting coated uniaxially oriented PET film susceptible to direct embossing by impregnating the surface of the uniaxially oriented PET film with at least a portion of the coating by transverse stretching the coated uniaxially oriented PET film;
applying a metal layer on the coating;
embossing the coating and the metal layer;
applying a low T_{g} laminating adhesive film to the metal layer;
laminating a transfer substrate to the adhesive layer; and
removing the PET base film.

41. The film of claim 1, wherein the secondary substrate is selected from the group consisting of cloth, paper board and a filmic material.
